(19) United States
(12) Patent Application Publication
(10) Pub. No.: US 2025/0106332 A1
(43) Pub. Date: Mar. 27, 2025

(54) IMAGE READING DEVICE AND IMAGE FORMING SYSTEM

(71) Applicant: FUJIFILM Business Innovation Corp., Tokyo (JP)

(72) Inventors: Taketoshi TANAKA, Kanagawa (JP); Tsutomu SOMEMIYA, Kanagawa (JP)

(73) Assignee: FUJIFILM Business Innovation Corp., Tokyo (JP)

(21) Appl. No.: 18/587,992

(22) Filed: Feb. 27, 2024

(30) Foreign Application Priority Data
Sep. 25, 2023 (JP) 2023-161548

(51) Int. Cl. H04N 1/00; H04N 1/12

(52) U.S. Cl. CPC H04N 1/00599; H04N 1/00246; H04N 1/1245; H04N 2201/0094

(57) ABSTRACT

An image reading device includes a transport section that transports a recording medium along a transport path, an image reading section that is provided on one side of the transport path and reads an image formed on the recording medium transported through the transport path, a rotary body that is rotatably provided and is provided on a side opposite to an installation side of the image reading section across the transport path, and a protruding portion that is provided at least at one end portion out of one end portion and the other end portion of the rotary body in an axial direction and protrudes from the rotary body toward the image reading section side.

### CROSS-REFERENCE TO RELATED APPLICATIONS

This application is based on and claims priority under 35 USC 119 from Japanese Patent Application No. 2023-161548 filed Sep. 25, 2023.

### BACKGROUND

### (i) Technical Field

The present disclosure relates to an image reading device and an image forming system.

### (ii) Related Art

Japanese Unexamined Patent Application Publication No. 2006-261859 discloses the configuration in which a white reference plate is provided on a photoelectric conversion element side with respect to a transport path and the color (white) of its own is directly read by the photoelectric conversion element at the time of preparation for shading correction.

Japanese Unexamined Patent Application Publication No. 2013-234074 discloses a document transport device including a sheet-like elastic member that extends in a document width direction and is provided in a form of protruding from a document transport surface of a document transport path into a document transport space.

### SUMMARY

In an image reading device that reads an image on a recording medium, for example, a configuration in which the recording medium passes between a rotary body and an image reading section provided at a position facing the rotary body may be adopted.

Here, in a case where there is a large gap between the rotary body and the image reading section, the behavior of the recording medium becomes unstable when the recording medium passes between the rotary body and the image reading section, and accordingly, there is a risk that the quality of image reading by the image reading section decreases.

Aspects of non-limiting embodiments of the present disclosure relate to improving the quality of image reading using an image reading section, as compared with a case where a recording medium is guided only by a rotary body and an image reading section provided at a position facing the rotary body when the recording medium passes between the rotary body and the image reading section.

Aspects of certain non-limiting exemplary embodiments of the present disclosure overcome the above disadvantages and/or other disadvantages not described above. However, aspects of the non-limiting exemplary embodiments are not required to overcome the disadvantages described above, and aspects of the non-limiting exemplary embodiments of the present disclosure may not overcome any of the disadvantages described above.

According to an aspect of the present disclosure, there is provided an image reading device including a transport section that transports a recording medium along a transport path, an image reading section that is provided on one side of the transport path and reads an image formed on the recording medium transported through the transport path, a rotary body that is rotatably provided and is provided on a side opposite to an installation side of the image reading section across the transport path, and a protruding portion that is provided at least at one end portion out of one end portion and the other end portion of the rotary body in an axial direction and protrudes from the rotary body toward the image reading section side.

### BRIEF DESCRIPTION OF THE DRAWINGS

An exemplary embodiment of the present disclosure will be described in detail based on the following figures, wherein:

FIG. 1 is a diagram illustrating an overall configuration of an image forming system;

FIG. 2 is a diagram illustrating a configuration example of hardware of a controller;

FIG. 3 is a diagram illustrating an image forming apparatus;

FIG. 4 is a vertical cross-sectional view of an inspection device and is a vertical cross-sectional view of the inspection device at an installation area of an upper rotary body;

FIG. 5 is an enlarged view of the upper rotary body and a light transmission unit;

FIG. 6 is a diagram illustrating a state where the upper rotary body, and the like, are viewed from obliquely below the upper rotary body;

FIG. 7 is a diagram when the upper rotary body is viewed from below the upper rotary body and from the direction indicated by arrow VII in FIG. 5;

FIG. 8 is a diagram illustrating an image reading range by a lower image reading unit;

FIG. 9 is a diagram illustrating a modification of an elastic body;

FIG. 10 is a diagram illustrating another configuration example of the upper rotary body;

FIG. 11 is a cross-sectional view of the upper rotary body taken along line XI-XI of FIG. 10; and

FIG. 12 is a diagram illustrating another configuration example of the upper rotary body.

### DETAILED DESCRIPTION

An exemplary embodiment of the disclosure will be described below with reference to the drawings.

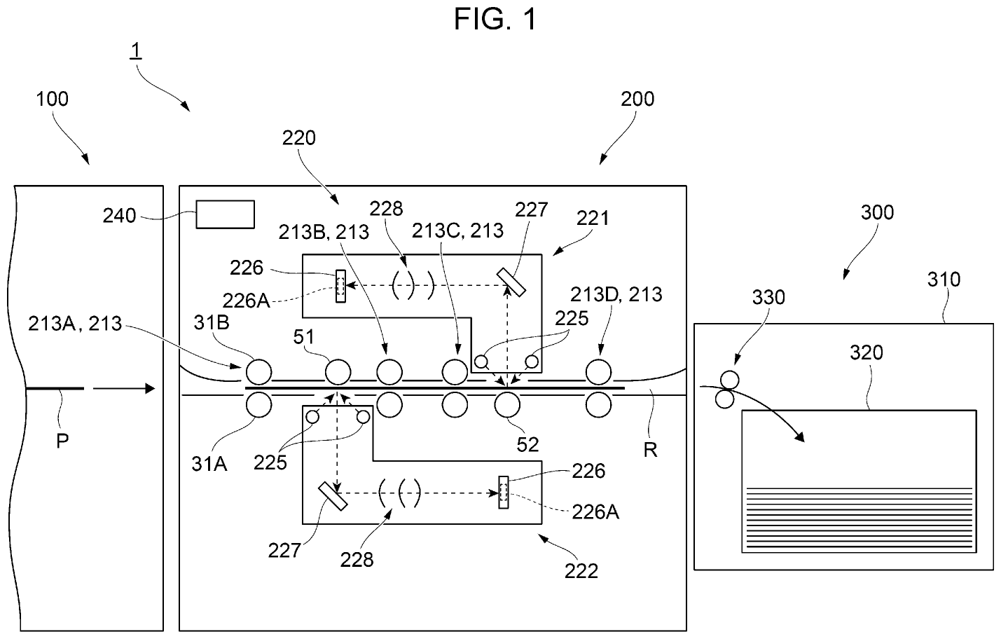

FIG. 1 is a diagram illustrating an overall configuration of an image forming system 1.

The image forming system 1 according to the present exemplary embodiment includes an image forming apparatus 100 that forms an image on paper P, which is an example of a recording medium, an inspection device 200 that inspects the image formed on the paper P by the image forming apparatus 100, and a paper accommodation device 300 that accommodates the paper P discharged from the inspection device 200.

The image forming system 1 has a function to inspect an image formed on the paper P and may also be regarded as an image inspection system.

Furthermore, the inspection device 200 has a function to transport the paper P, which is an example of a recording medium, and may be regarded as a recording medium transport device. Furthermore, the inspection device 200 has a function to read an image formed on the paper P and may be regarded as an image reading device.

The image forming apparatus 100 functioning as an image forming section acquires image data, based on which an image is formed, from a personal computer (PC) (not illustrated) or the like.

The image forming apparatus 100 forms an image on the paper P, which is an example of a recording medium, with use of a material such as toner based on the acquired image data.

A mechanism that forms an image on the paper P is not particularly limited. The image formation on the paper P is performed using, for example, an electrophotographic method or an inkjet method.

The inspection device 200 includes a paper transport path R, which is an example of a transport path along which the paper P discharged from the image forming apparatus 100 is transported.

Furthermore, the inspection device 200 also includes a plurality of transport rollers 213, which is an example of a transport section that transports the paper P along the paper transport path R. According to the present exemplary embodiment, the paper P is transported to the downstream side by the plurality of transport rollers 213.

According to the present exemplary embodiment, an upstream transport roller 213A provided on the most upstream side in the transport direction of the paper P is provided as the transport roller 213. Furthermore, a downstream transport roller 213D is provided on the most downstream side in the transport direction of the paper P.

Further, a first intermediate transport roller 213B and a second intermediate transport roller 213C, which is located downstream of the first intermediate transport roller 213B, are provided between the upstream transport roller 213A and the downstream transport roller 213D.

Each of the transport rollers 213 is configurated by a driving roller 31A, which performs rotational driving, and a driven roller 31B, which is pressed against the driving roller 31A and rotates by receiving a driving force from the driving roller 31A.

The driven roller 31B receives a driving force from the driving roller 31A at a contact portion where the driving roller 31A and the driven roller 31B are in contact with each other. The driven roller 31B rotates by receiving a driving force from the driving roller 31A with the rotation of the driving roller 31A.

Furthermore, the inspection device 200 includes an image reading unit 220 that reads an image formed on the paper P.

According to the present exemplary embodiment, as the image reading unit 220, an upper image reading unit 221 and a lower image reading unit 222 are provided, which are an example of an image reading section.

The upper image reading unit 221 is located above the paper transport path R. The upper image reading unit 221 reads an image formed on an upper surface that is an example of one surface out of two surfaces of the paper P.

Furthermore, the lower image reading unit 222 is provided below the paper transport path R. The lower image reading unit 222 reads an image formed on a lower surface that is an example of the other surface out of the two surfaces of the paper P.

Furthermore, the inspection device 200 includes a controller 240. The controller 240 controls each unit included in the inspection device 200.

The upper image reading unit 221 and the lower image reading unit 222 each include a light source 225 that radiates light to the paper P, a light receiving unit 226 that receives reflected light from the paper P, and a light reflecting member 227 that reflects the reflected light from the paper P and directs the reflected light to the light receiving unit 226.

The light receiving unit 226 includes a plurality of light receiving elements 226A configurated by photodiodes, or the like, so that the plurality of light receiving elements 226A receives the light reflected from the paper P.

The plurality of light receiving elements 226A is arranged along one direction. Specifically, they are aligned along a direction perpendicular to the sheet surface of FIG. 1.

In other words, the plurality of light receiving elements 226A is aligned along a direction perpendicular to the transport direction of the paper P in the inspection device 200 and perpendicular to the thickness direction of the transported paper P.

Furthermore, the upper image reading unit 221 and the lower image reading unit 222 each include an imaging optical system 228 such as a lens that forms an image of the reflected light from the light reflecting member 227 on the light receiving unit 226.

According to the present exemplary embodiment, the upper image reading unit 221 and the lower image reading unit 222 each serve as an image reading unit including a reduction optical system.

Further, according to the present exemplary embodiment, a rotatable upper rotary body 51 is provided on the side opposite to the installation side of the lower image reading unit 222 across the paper transport path R. Furthermore, a rotatable lower rotary body 52 is provided on the opposite side to the installation side of the upper image reading unit 221 across the paper transport path R.

Further, according to the present exemplary embodiment, a drive motor (not illustrated), which is a drive source to rotate the upper rotary body 51, and a drive motor (not illustrated), which is a drive source to rotate the lower rotary body 52, are provided.

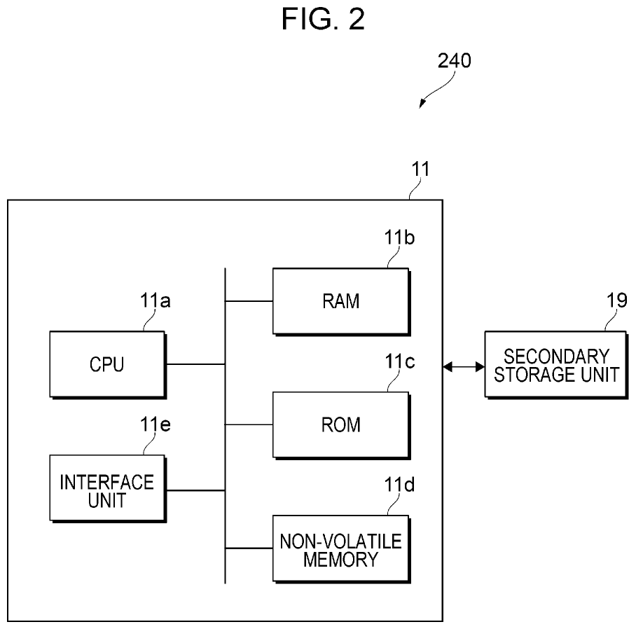

FIG. 2 is a diagram illustrating a configuration example of hardware of the controller 240. The controller 240 is implemented by a computer.

The controller 240 includes an arithmetic processing unit 11 that executes digital arithmetic processing in accordance with a program and a secondary storage unit 19 that stores information.

The secondary storage unit 19 is implemented by an existing information storage device, such as a hard disk drive (HDD), a semiconductor memory, or a magnetic tape.

The arithmetic processing unit 11 includes a CPU 11a, which is an example of a processor.

Furthermore, the arithmetic processing unit 11 includes a RAM 11b used as a working memory or the like of the CPU 11a and a ROM 11c that stores a program or the like to be executed by the CPU 11a.

Further, the arithmetic processing unit 11 includes a non-volatile memory 11d that is configurated to be rewritable and may hold data even when power supply is stopped and an interface unit 11e that controls each unit such as a communication unit connected to the arithmetic processing unit 11.

The non-volatile memory 11d is configurated by, for example, a battery-backed SRAM or flash memory. The secondary storage unit 19 stores various types of information such as programs to be executed by the arithmetic processing unit 11.

According to the present exemplary embodiment, the arithmetic processing unit 11 reads a program stored in the ROM 11c or the secondary storage unit 19 and thus executes processing performed in the inspection device 200.

The program to be executed by the CPU 11a may be provided to the inspection device 200 in a state of being stored in a computer-readable recording medium such as a magnetic recording medium (a magnetic tape, a magnetic disk, or the like), an optical recording medium (an optical disc or the like), a magneto-optical recording medium, or a semiconductor memory. Furthermore, the program to be executed by the CPU 11a may be provided to the inspection device 200 by using a communication way such as the Internet.

In this description, the processor refers to a processor in a broad sense and includes general-purpose processors (for example, a central processing unit (CPU)) and dedicated processors (for example, graphics processing unit (GPU), application specific integrated circuit (ASIC), Field Programmable Gate Array (FPGA), or programmable logic devices).

Further, the operation of the processor may be performed not only by one processor but also by a plurality of processors existing at physically distant positions in cooperation with each other. Furthermore, the order of the operations of the processor is not limited to only the order described in the present exemplary embodiment and may be changed.

The image forming system 1 will be further described with reference to FIG. 1.

The paper accommodation device 300 includes a housing 310. Furthermore, the paper accommodation device 300 includes a paper stacking unit 320.

The paper stacking unit 320 is installed inside the housing 310 and, according to the present exemplary embodiment, the paper stacking unit 320 stacks the sheets of paper P sequentially discharged from the inspection device 200.

Furthermore, the paper accommodation device 300 includes a sending roller 330 that sends the paper P discharged from the inspection device 200 to the paper stacking unit 320.

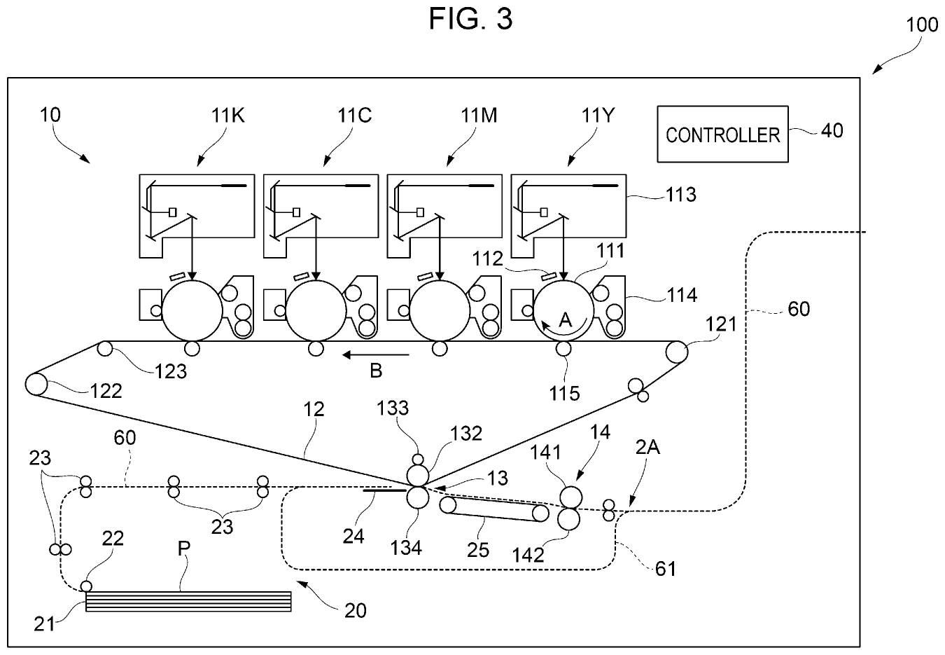

FIG. 3 is a diagram illustrating the image forming apparatus 100.

FIG. 3 illustrates an example of the image forming apparatus 100, and the apparatus configuration of the image forming apparatus 100 is not limited to the one illustrated in FIG. 3. Although the image forming apparatus 100 illustrated in FIG. 3 is an apparatus that forms an image using what is called an electrophotographic system, the image forming apparatus 100 may be, for example, an apparatus that forms an image using an inkjet system.

Furthermore, the image forming apparatus 100 may be an apparatus that forms an image using a system other than the electrophotographic system or the inkjet system.

The image forming apparatus 100 includes an image forming part 10, a paper transport unit 20, and a controller 40.

The image forming part 10 includes image forming units 11 (11Y, 11M, 11C, and 11K), an intermediate transfer belt 12, a secondary transfer unit 13, and a fixing device 14.

According to the present exemplary embodiment, as the image forming units 11, the four image forming units 11Y, 11M, 11C, and 11K corresponding to toners of four colors of Y (yellow), M (magenta), C (cyan), and K (black) are provided.

The four image forming units 11Y, 11M, 11C, and 11K are arranged side by side in the moving direction of the intermediate transfer belt 12 and form toner images by an electrophotographic system.

Each of the four image forming units 11Y, 11M, 11C, and 11K includes a photoconductor drum 111, a charge unit 112, an exposure unit 113, a developing unit 114, and a primary transfer unit 115.

Each of the four image forming units 11Y, 11M, 11C, and 11K forms a toner image in one of the colors Y, M, C, and K and transfers the formed toner image onto the intermediate transfer belt 12. Accordingly, a toner image in which the toner images of the respective colors of Y, M, C, and K are superimposed is formed on the intermediate transfer belt 12.

The photoconductor drum 111 rotates in a direction of an arrow A in the drawing at a predetermined speed. The charge unit 112 charges the peripheral surface of the photoconductor drum 111 to a predetermined potential. The exposure unit 113 radiates light to the charged peripheral surface of the photoconductor drum 111 to form an electrostatic latent image on the peripheral surface of the photoconductor drum 111.

The developing unit 114 attaches toner to the electrostatic latent image formed on the peripheral surface of the photoconductor drum 111 to form a toner image. The primary transfer unit 115 transfers the toner image formed on the peripheral surface of the photoconductor drum 111 to the intermediate transfer belt 12.

A voltage having a polarity opposite to a charging polarity of the toner is applied to the primary transfer unit 115. Thus, the toner images formed on the peripheral surface of the photoconductor drum 111 are sequentially electrostatically attracted onto the intermediate transfer belt 12. As a result, a single superimposed color toner image is formed on the intermediate transfer belt 12.

The intermediate transfer belt 12 is supported by a plurality of roll-shaped members. The intermediate transfer belt 12 is a belt-like member that circulates in the direction of an arrow B in the drawing.

According to the present exemplary embodiment, as the roll-shaped members, a driving roller 121 that is driven by a motor (not illustrated) and drives the intermediate transfer belt 12, a tension roller 122 that applies tension to the intermediate transfer belt 12, an idle roller 123 that supports the intermediate transfer belt 12, and a backup roller 132 are provided.

The paper transport unit 20 includes a paper accommodation unit 21 that accommodates the plurality of sheets of paper P in a stacked state and a pickup roller 22 that picks up and transports the paper P accommodated in the paper accommodation unit 21.

Furthermore, the paper transport unit 20 includes a transport roller 23 that transports the paper P picked up by the pickup roller 22 along a paper transport path 60 and a guide unit 24 that guides the paper P transported by the transport roller 23 to the secondary transfer unit 13.

Furthermore, the paper transport unit 20 includes a transport belt 25 that transports the paper P after the secondary transfer to the fixing device 14.

The secondary transfer unit 13 includes a secondary transfer roller 134 provided in contact with the outer surface of the intermediate transfer belt 12 and the backup roller 132 provided on the inner side of the intermediate transfer belt 12 and serving as a counter electrode of the secondary transfer roller 134.

Further, according to the present exemplary embodiment, a metallic power supply roller 133 that applies a secondary transfer bias to the backup roller 132 is provided.

At the secondary transfer unit 13, the toner image formed on the intermediate transfer belt 12 is transferred onto the transported paper P.

The fixing device 14 is located downstream of the secondary transfer unit 13 in the transport direction of the paper P. The fixing device 14 includes a fixing roller 141 including a heat source (not illustrated) and a pressure roller 142 that is provided to face the fixing roller 141 and press the fixing roller.

According to the present exemplary embodiment, the paper P having passed through the secondary transfer unit 13 is transported between the fixing roller 141 and the pressure roller 142, and the unfixed toner image on the paper P is melted and then fixed onto the paper P. Accordingly, the image including the toner image is formed on the paper P.

Further, in the image forming apparatus 100 according to the present exemplary embodiment, images may be formed on both sides of the paper P, and a reverse transport path 61 used for forming images on both sides of the paper P is provided.

The reverse transport path 61 is provided in a form of branching from the paper transport path 60 on the downstream side of the fixing device 14. When a connection portion 2A with the paper transport path 60 is set as a starting point, the reverse transport path 61 is directed to the left in the drawing and merges with the paper transport path 60 on the upstream side of the secondary transfer unit 13.

When images are formed on both sides of the paper P, the paper P having an image formed on one surface is once transported to the downstream side of the connection portion 2A. Then, the transport direction of the paper P is reversed, and the paper P is fed into the reverse transport path 61 with the end portion that has been located at the rear end portion of the paper P in the transport direction as the leading end.

Then, the paper P is supplied again to the secondary transfer unit 13 via the reverse transport path 61.

Accordingly, the toner image is transferred to the other surface of the paper P at the secondary transfer unit 13. Then, the paper P is directed to the fixing device 14, and the fixing device 14 fixes the toner image onto the paper P. Through this processing, images are formed on both sides of the paper P.

The mode of image formation on both sides of the paper P is not limited to this. For example, image forming parts may be provided for one surface and the other surface of the paper P, respectively, and the image forming parts provided for the respective sides of the paper P may be used to form images on both sides of the paper P.

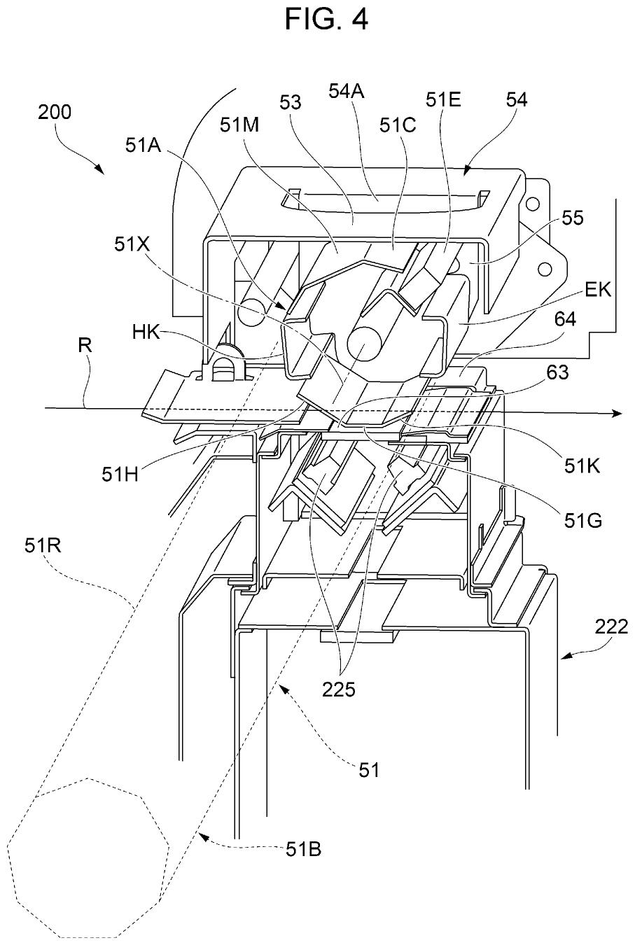

FIG. 4 is a vertical cross-sectional view of the inspection device 200 and is a vertical cross-sectional view of the inspection device 200 at the installation area of the upper rotary body 51.

More specifically, FIG. 4 is a cross-sectional view of the inspection device 200 in a plane perpendicular to the axial direction of the upper rotary body 51 and passing through the side closer to one end portion 51A of the upper rotary body 51.

According to the present exemplary embodiment, the upper rotary body 51, which is an example of a rotary body, includes the one end portion 51A and the other end portion 51B whose positions in the axial direction are different from each other. FIG. 4 illustrates a cross-sectional state of the inspection device 200 in a vertical plane located on the side closer to the one end portion 51A.

The upper rotary body 51 and the lower image reading unit 222 will be described below, but the lower rotary body 52 (see FIG. 1) and the upper image reading unit 221 also have the same configurations as the upper rotary body 51 and the lower image reading unit 222.

According to the present exemplary embodiment, the lower image reading unit 222 (see FIG. 4), which is an example of an image reading section, is provided on the lower side that is one side of the paper transport path R. The lower image reading unit 222 reads an image formed on one surface of the paper P transported through the paper transport path R.

The lower image reading unit 222 includes a light transmission unit 63 that is provided on the lower side, which is one side of the paper transport path R, and allows transmission of the reflected light from the paper P.

The light transmission unit 63 is a plate-like member. The light transmission unit 63 is configurated by glass, or the like. As the light transmission unit 63, a material other than glass may be used as long as the material may allow transmission of light.

Furthermore, the lower image reading unit 222 includes an arrangement member 64 that is arranged around the light transmission unit 63. According to the present exemplary embodiment, the light transmission unit 63 is supported by the arrangement member 64.

According to the present exemplary embodiment, the upper rotary body 51 is provided on the side opposite to the installation side of the lower image reading unit 222 across the paper transport path R. The upper rotary body 51 is provided in a rotatable state.

The upper rotary body 51 is formed in a polygonal shape, and an outer peripheral surface 51R of the upper rotary body 51 includes a plurality of plane surfaces 51C arranged in the circumferential direction of the upper rotary body 51.

The plurality of plane surfaces 51C is provided such that their positions in the circumferential direction of the upper rotary body 51 are different from each other.

Furthermore, each of the plurality of plane surfaces 51C faces outward in the radial direction of the upper rotary body 51. In other words, each of the plurality of plane surfaces 51C faces the side opposite to the side where a rotation axis 51X of the upper rotary body 51 is located.

According to the present exemplary embodiment, a white reference plate HK, which is white and is an example of a calibration member, is provided for a part of the plurality of plane surfaces 51C.

Furthermore, a color calibration plate EK, which is another example of the calibration member, is provided for another part of the plane surfaces 51C.

The white reference plate HK and the color calibration plate EK are formed in an elongated shape and are provided along the axial direction of the upper rotary body 51. On the color calibration plate EK, for example, a plurality of color patches in different colors is arranged side by side in the axial direction of the upper rotary body 51.

According to the present exemplary embodiment, when the paper P is not transported, the upper rotary body 51 is rotated to cause the white reference plate HK and the color calibration plate EK to face the lower image reading unit 222.

Then, the lower image reading unit 222 reads the white reference plate HK and the color calibration plate EK.

Then, according to the present exemplary embodiment, the lower image reading unit 222 is calibrated based on the reading result by the lower image reading unit 222.

Specifically, based on the reading result, for example, a correction parameter used for correction of image data obtained by reading of the lower image reading unit 222 is generated.

Further, based on the reading result, for example, a reading condition when the lower image reading unit 222 reads an image is changed.

Furthermore, according to the present exemplary embodiment, a cleaning member 51E is provided for another part of the plane surfaces 51C of the upper rotary body 51. The cleaning member 51E cleans the lower image reading unit 222.

According to the present exemplary embodiment, when the upper rotary body 51 rotates, the cleaning member 51E moves in contact with the light transmission unit 63, which is an example of a portion to be cleaned. Thus, the light transmission unit 63 is cleaned.

The shape and material of the cleaning member 51E are not particularly limited. The cleaning member 51E is configurated by, for example, a nonwoven fabric or an elastic porous material.

Furthermore, according to the present exemplary embodiment, the upper rotary body 51 includes a reading guide surface 51G.

According to the present exemplary embodiment, when the lower image reading unit 222 reads the image on the paper P, the reading guide surface 51G is located above the paper transport path R and guides the paper P passing through the paper transport path R.

The reading guide surface 51G is provided as a part of the outer peripheral surface 51R of the upper rotary body 51. The reading guide surface 51G is configurated by one of the plane surfaces 51C provided on the outer peripheral surface 51R of the upper rotary body 51.

According to the present exemplary embodiment, when the lower image reading unit 222 reads the image on the paper P, the reading guide surface 51G is provided in a state of facing the lower image reading unit 222. More specifically, the reading guide surface 51G is provided in a state of facing the light transmission unit 63.

Furthermore, when the lower image reading unit 222 reads the image on the paper P, the reading guide surface 51G is provided in a state of being parallel to the light transmission unit 63.

According to the present exemplary embodiment, when the lower image reading unit 222 reads the image on the paper P, the paper P passes between the reading guide surface 51G and the light transmission unit 63.

At this time, the paper P is guided by the reading guide surface 51G and the light transmission unit 63.

Furthermore, according to the present exemplary embodiment, when the paper P passes between the reading guide surface 51G and the light transmission unit 63, the lower image reading unit 222 reads the image formed on the paper P.

Furthermore, according to the present exemplary embodiment, the upper rotary body 51 includes an upstream guide surface 51H and a downstream guide surface 51K. The upstream guide surface 51H and the downstream guide surface 51K are also configurated by the plane surfaces 51C included in the upper rotary body 51.

When the reading guide surface 51G is in a state of facing the light transmission unit 63, the upstream guide surface 51H is located upstream of the reading guide surface 51G in the transport direction of the paper P.

Furthermore, when the reading guide surface 51G is in a state of facing the light transmission unit 63, the upstream guide surface 51H is provided in a state of being inclined with respect to the transport direction of the paper P.

Furthermore, when the reading guide surface 51G is in a state of facing the light transmission unit 63, the upstream guide surface 51H is provided to become gradually closer to the light transmission unit 63 as the upstream guide surface 51H extends to the downstream side in the transport direction of the paper P.

When the reading guide surface 51G is in a state of facing the light transmission unit 63, the downstream guide surface 51K is located downstream of the reading guide surface 51G in the transport direction of the paper P.

Further, when the reading guide surface 51G is in a state of facing the light transmission unit 63, the downstream guide surface 51K is provided in a state of being inclined with respect to the transport direction of the paper P.

Furthermore, when the reading guide surface 51G is in a state of facing the light transmission unit 63, the downstream guide surface 51K is provided to become gradually farther from the light transmission unit 63 as the downstream guide surface 51K extends to the downstream side in the transport direction of the paper P.

The reading guide surface 51G, the upstream guide surface 51H, and the downstream guide surface 51K are formed by bending a single metal plate.

Thus, according to the present exemplary embodiment, the reading guide surface 51G, the upstream guide surface 51H, and the downstream guide surface 51K are integral with each other.

Further, as described below, the upper rotary body 51 according to the present exemplary embodiment includes a protruding portion that protrudes from the upper rotary body 51 toward the lower image reading unit 222 side.

Furthermore, according to the present exemplary embodiment, another part of the plane surfaces 51C included in the upper rotary body 51 configurates a transport guide surface 51M.

According to the present exemplary embodiment, in a case where the paper P is passed between the light transmission unit 63 and the upper rotary body 51 without reading an image by the lower image reading unit 222, the upper rotary body 51 is rotated so that the transport guide surface 51M faces the light transmission unit 63.

According to the present exemplary embodiment, the separation distance between the transport guide surface 51M and the light transmission unit 63 when the transport guide surface 51M is in a state of facing the light transmission unit 63 is larger than the separation distance between the reading guide surface 51G and the light transmission unit 63 when the reading guide surface 51G is in a state of facing the light transmission unit 63.

The upper rotary body 51 includes, as the plane surfaces 51C, at least the two plane surfaces 51C whose distances from the rotation axis 51X of the upper rotary body 51 are different from each other.

Specifically, as the two plane surfaces 51C, the transport guide surface 51M and the reading guide surface 51G are provided.

According to the present exemplary embodiment, as described above, the separation distance between the transport guide surface 51M and the light transmission unit 63 when the transport guide surface 51M is in a state of facing the light transmission unit 63 is larger than the separation distance between the reading guide surface 51G and the light transmission unit 63 when the reading guide surface 51G is in a state of facing the light transmission unit 63.

Furthermore, according to the present exemplary embodiment, a retraction unit 53 is provided to be able to retract from the paper transport path R. The retraction unit 53 is provided above the paper transport path R. The retraction unit 53 is movable upward. Further, the retraction unit 53 is provided to extend along the axial direction of the upper rotary body 51.

According to the present exemplary embodiment, the retraction unit 53 supports the one end portion 51A and the other end portion 51B of the upper rotary body 51 in the axial direction. According to the present exemplary embodiment, when the retraction unit 53 moves upward, the upper rotary body 51 moves in a direction away from the lower image reading unit 222.

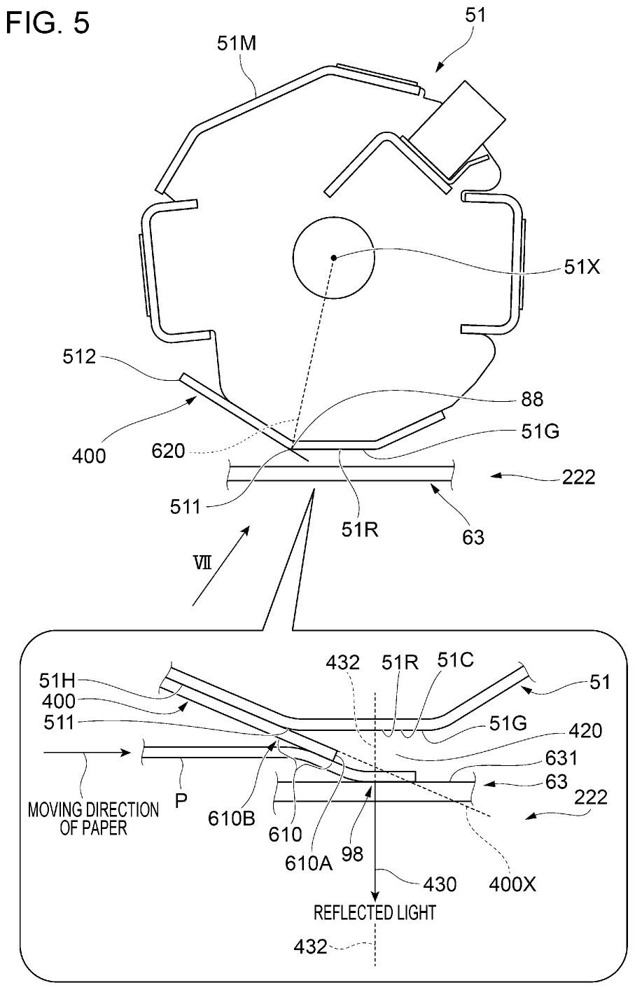

FIG. 5 is an enlarged view of the upper rotary body 51 and the light transmission unit 63.

According to the present exemplary embodiment, an elastic body 400 is attached to the upper rotary body 51.

The elastic body 400 is configurated by a plate-like member. The material of the elastic body 400 is not particularly limited. Examples of the material of the elastic body 400 include a resin material.

According to the present exemplary embodiment, as illustrated in FIG. 5, a part of the elastic body 400 is in a state of protruding from the outer peripheral surface 51R of the upper rotary body 51.

According to the present exemplary embodiment, by the protrusion of the part of the elastic body 400, a protruding portion 610 is provided, which protrudes from the outer peripheral surface 51R of the upper rotary body 51.

The protruding portion 610 protrudes from the upper rotary body 51 toward the lower image reading unit 222.

The protruding portion 610 includes an edge portion 610A located at the leading end in the protruding direction and a base portion 610B located on the outer peripheral surface 51R side of the upper rotary body 51.

The edge portion 610A is provided in a form of extending in the axial direction of the upper rotary body 51. In other words, the edge portion 610A extends in a direction perpendicular to the sheet surface of FIG. 5.

According to the present exemplary embodiment, the protruding portion 610 is inclined with respect to a straight line 620 extending from the rotation axis 51X of the upper rotary body 51 toward the base portion 610B of the protruding portion 610. The straight line 620 extends along the radial direction of the upper rotary body 51, and the protruding portion 610 is inclined with respect to the radial direction.

As a result of the protruding portion 610 being inclined in this manner, according to the present exemplary embodiment, the position of the base portion 610B in the circumferential direction of the upper rotary body 51 and the position of the edge portion 610A in the circumferential direction of the upper rotary body 51 are different from each other.

According to the present exemplary embodiment, when a specific portion of the outer peripheral surface 51R of the upper rotary body 51 is in a state of facing the lower image reading unit 222, the protruding portion 610 is in a state of protruding toward the lower image reading unit 222 side.

In other words, according to the present exemplary embodiment, when a specific portion of the outer peripheral surface 51R of the upper rotary body 51 is in a state of facing the lower image reading unit 222, the protruding portion 610 is provided in a form of extending toward the lower image reading unit 222 side.

More specifically, according to the present exemplary embodiment, when the reading guide surface 51G, which is provided as a part of the outer peripheral surface 51R of the upper rotary body 51, is in a state of facing the light transmission unit 63 provided in the lower image reading unit 222, the protruding portion 610 is in a state of protruding toward the lower image reading unit 222 side.

More specifically, according to the present exemplary embodiment, the protruding portion 610 protrudes toward an area of the lower image reading unit 222 where the light transmission unit 63 is provided.

According to the present exemplary embodiment, as described above, the separation distance between the transport guide surface 51M and the light transmission unit 63 is larger than the separation distance between the reading guide surface 51G and the light transmission unit 63.

Furthermore, according to the present exemplary embodiment, the separation distance between the rotation axis 51X of the upper rotary body 51 and the reading guide surface 51G is larger than the separation distance between the rotation axis 51X of the upper rotary body 51 and the transport guide surface 51M.

FIG. 5 illustrates that the reading guide surface 51G, which is the plane surface 51C having a larger distance from the rotation axis 51X of the upper rotary body 51, is in a state of facing the lower image reading unit 222.

According to the present exemplary embodiment, when the reading guide surface 51G is in a state of facing the lower image reading unit 222, the protruding portion 610 protrudes toward the lower image reading unit 222 side.

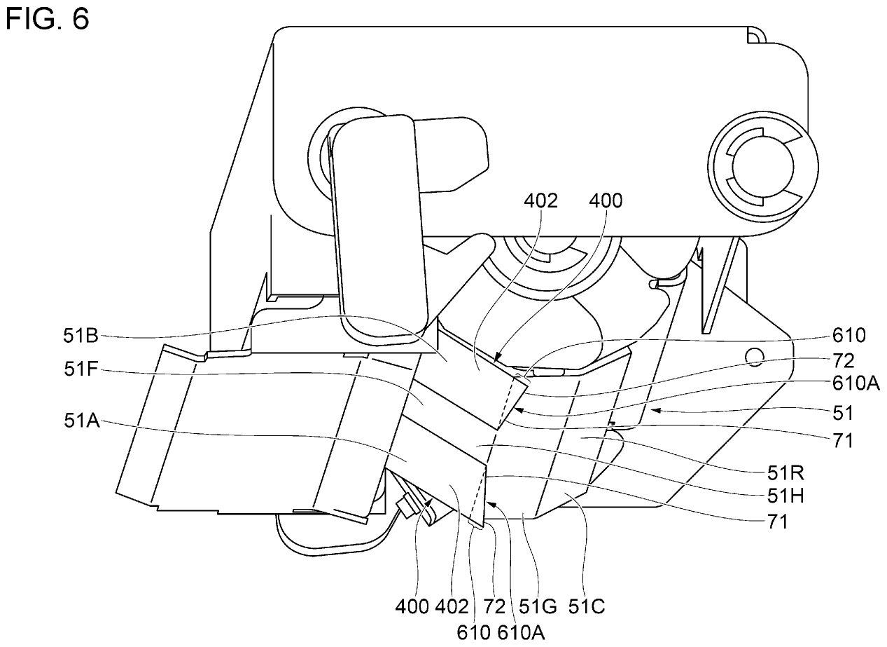

FIG. 6 is a diagram illustrating a state where the upper rotary body 51, and the like, are viewed from obliquely below the upper rotary body 51.

According to the present exemplary embodiment, as illustrated in FIG. 6, the protruding portions 610 are provided on the one end portion 51A and the other end portion 51B of the upper rotary body 51 in the axial direction.

The protruding portion 610 is not provided in a central portion 51F of the upper rotary body 51 in the axial direction.

Further, the protruding portion 610 may be provided at only one end portion out of the one end portion 51A and the other end portion 51B of the upper rotary body 51 in the axial direction. According to the present exemplary embodiment, the protruding portion 610 is provided at least at one end portion out of the one end portion 51A and the other end portion 51B of the upper rotary body 51 in the axial direction.

Further, it is not excluded that the protruding portion 610 is provided at the central portion 51F of the upper rotary body 51 in the axial direction, and the protruding portion 610 may be provided also at the central portion 51F of the upper rotary body 51 in the axial direction.

Further, when the protruding portion 610 is also provided at the central portion 51F of the upper rotary body 51 in the axial direction, the protrusion amount of the protruding portion 610 provided at the central portion 51F is preferably smaller than the protrusion amount of the protruding portions 610 provided at the one end portion 51A and the other end portion 51B of the upper rotary body 51.

More specifically, the protrusion amount of the protruding portion 610 provided at the central portion 51F is preferably smaller than the protrusion amount of the portion having the smallest protrusion amount out of the protruding portions 610 provided at the one end portion 51A and the other end portion 51B.

According to the present exemplary embodiment, as described above and as illustrated in FIG. 6, the outer peripheral surface 51R of the upper rotary body 51 includes the plurality of plane surfaces 51C whose positions in the circumferential direction of the upper rotary body 51 are different from each other.

The elastic body 400 configurating the protruding portion 610 is attached to the one plane surface 51C out of the plurality of plane surfaces 51C.

Specifically, the elastic body 400 is attached to the upstream guide surface 51H.

According to the present exemplary embodiment, the elastic body 400 is attached to the upstream guide surface 51H in a state where one surface of the elastic body 400 and the upstream guide surface 51H are in surface contact with each other.

In other words, according to the present exemplary embodiment, the elastic body 400 is attached to the one plane surface 51C in a state where one surface of the elastic body 400 and the one plane surface 51C of the upper rotary body 51 are in surface contact with each other.

The elastic body 400 is formed like a plate and has two surfaces, one surface and the other surface 402. According to the present exemplary embodiment, the elastic body 400 is attached to the one plane surface 51C in a state where one surface out of the two surfaces is in surface contact with the one plane surface 51C of the upper rotary body 51.

More particularly, according to the present exemplary embodiment, the elastic body 400 is attached to the one plane surface 51C of the upper rotary body 51 with a double-sided tape (not illustrated) provided between the one surface of the elastic body 400 and the one plane surface 51C.

Furthermore, the elastic body 400 may be attached to the one plane surface 51C with not only a double-sided tape but also a fastening member such as a screw, or an adhesive, etc.

Here, the “state where one surface of the elastic body 400 and the one plane surface 51C of the rotary body are in surface contact with each other” is not limited to a state where one surface of the elastic body 400 and the one plane surface 51C of the rotary body are in direct contact with each other, but also includes a state where they are in contact with each other via another member such as the double-sided tape described above.

According to the present exemplary embodiment, when the lower image reading unit 222 reads an image, as illustrated in FIG. 4, the reading guide surface 51G included in the plurality of plane surfaces 51C provided on the outer peripheral surface 51R of the upper rotary body 51 faces the lower image reading unit 222.

Furthermore, when the lower image reading unit 222 reads an image, the upstream guide surface 51H, which is an example of the other plane surface 51C, is located upstream of the reading guide surface 51G in the moving direction of the paper P.

As illustrated in FIG. 6, the elastic body 400 is supported by the upstream guide surface 51H of the upper rotary body 51.

As illustrated in FIG. 5, the protruding portion 610 configurated by the elastic body 400 protrudes from one end portion 511 of the upstream guide surface 51H toward the light transmission unit 63 provided in the lower image reading unit 222.

As illustrated in FIG. 5, the upstream guide surface 51H has the one end portion 511 and the other end portion 512 whose positions in the circumferential direction of the upper rotary body 51 are different from each other.

The one end portion 511 is located on the side closer to the reading guide surface 51G, and the other end portion 512 is located on the side farther from the reading guide surface 51G.

As illustrated in FIG. 5, the protruding portion 610 protrudes from the one end portion 511 located on the side closer to the reading guide surface 51G toward the light transmission unit 63 provided in the lower image reading unit 222.

In other words, the protruding portion 610 protrudes from a joint portion 88 between the upstream guide surface 51H and the reading guide surface 51G toward the light transmission unit 63 provided in the lower image reading unit 222.

In FIG. 5, the reading guide surface 51G of the upper rotary body 51 is in a state of facing the lower image reading unit 222. In this state, the protruding portion 610 configurated by a part of the elastic body 400 is in the state of being provided at the position facing the lower image reading unit 222.

In FIG. 5, the protruding portion 610 is provided in an inclined state to become gradually closer to the light transmission unit 63 provided in the lower image reading unit 222 as the protruding portion 610 extends to the downstream side in the transport direction of the paper P.

In other words, in FIG. 5, the protruding portion 610 is provided in an inclined state to become gradually closer to a guide surface 631 provided in the lower image reading unit 222 as the protruding portion 610 extends to the downstream side in the moving direction of the paper P.

The light transmission unit 63 includes the guide surface 631 that guides the transported paper P. The protruding portion 610 is provided in an inclined state to become gradually closer to the guide surface 631 as the protruding portion 610 extends to the downstream side in the transport direction of the paper P.

The upstream guide surface 51H is provided in a form of extending from the other end portion 512 toward the one end portion 511.

When the lower image reading unit 222 reads an image, the light transmission unit 63 of the lower image reading unit 222 is located on an extended surface 400X of the upstream guide surface 51H extending from the other end portion 512 toward the one end portion 511.

In other words, according to the present exemplary embodiment, the guide surface 631 configurated by one surface of the light transmission unit 63 is located on the extended surface 400X of the upstream guide surface 51H extending from the other end portion 512 toward the one end portion 511.

When the lower image reading unit 222 reads an image on the paper P, as illustrated in FIG. 5, the reading guide surface 51G provided as a part of the outer peripheral surface 51R of the upper rotary body 51 is in a state of facing the lower image reading unit 222.

According to the present exemplary embodiment, when the reading guide surface 51G is in a state of facing the lower image reading unit 222, the protruding portion 610 configurated by a part of the elastic body 400 protrudes toward the lower image reading unit 222 side.

As illustrated in FIG. 5, the protruding portion 610 is provided in a state of being located in a gap 420 between the reading guide surface 51G and the lower image reading unit 222.

The protruding portion 610 is provided in a non-contact state with the lower image reading unit 222 and is provided in a state of having a gap with the lower image reading unit 222.

More specifically, the protruding portion 610 is provided in a non-contact state with the light transmission unit 63 of the lower image reading unit 222 and is provided in a state of having a gap with the light transmission unit 63.

When the protruding portion 610 is provided in a state of having the gap with the light transmission unit 63, a load applied to the paper P from the protruding portion 610 when the paper P passes through the protruding portion 610 is reduced.

In this case, jams of the paper P due to the load applied to the paper P are less likely to occur.

Among the surfaces of the light transmission unit 63, the surface facing the upper rotary body 51 side functions as the guide surface 631 that guides the transported paper P. The lower image reading unit 222 includes the guide surface 631, which guides the transported paper P, at the area where the light transmission unit 63 is provided.

The guide surface 631 is provided at the position facing the upper rotary body 51. Furthermore, the guide surface 631 is provided in a form of extending along the moving direction of the transported paper P and is in contact with one surface of the paper P to guide the paper P.

According to the present exemplary embodiment, as illustrated in FIG. 5, the protruding portion 610 is provided in a state of being inclined with respect to the guide surface 631. More specifically, the protruding portion 610 is provided to become gradually closer to the guide surface 631 as the protruding portion 610 extends to the downstream side in the moving direction of the paper P.

According to the present exemplary embodiment, the paper P whose image is read by the lower image reading unit 222 passes between the light transmission unit 63 of the lower image reading unit 222 and the reading guide surface 51G of the upper rotary body 51.

At this time, the paper P is guided by the protruding portion 610 and biased toward the light transmission unit 63. In other words, the paper P is guided by the protruding portion 610 to move to the light transmission unit 63 side.

Thus, the displacement of the paper P in the thickness direction of the paper P is reduced, and image reading by the lower image reading unit 222 is stabilized as compared with a configuration in which the protruding portion 610 is not provided.

According to the present exemplary embodiment, the case where the protruding portion 610 is provided such that the protruding portion 610 and the light transmission unit 63 are not in contact with each other has been described as an example, but the protruding portion 610 may be provided such that the protruding portion 610 and the light transmission unit 63 are in contact with each other.

Furthermore, according to the present exemplary embodiment, as illustrated in FIG. 5, the protruding portion 610 is provided at an area deviated from a virtual plane 432 along an optical axis 430 of the reflected light directed to the light receiving unit 226 (see FIG. 1) from the paper P.

The virtual plane 432 is a virtual plane along the optical axis 430 of the reflected light and is a virtual plane along the width direction of the moving paper P.

Hereinafter, in this description, the virtual plane 432 is referred to as the “width-direction plane 432”.

Here, the above-described “width direction of the paper P” refers to the direction in which the side extending along a direction perpendicular to the transport direction of the paper P extends among the four sides of the paper P transported and moved to the downstream side.

The paper P according to the present exemplary embodiment is formed in a rectangular shape and has four sides. The “width direction of the paper P” refers to the extending direction of the side that extends along a direction perpendicular to the transport direction of the paper P among the four sides.

Further, the “width direction of the paper P” may also be said to be a direction perpendicular to both the moving direction of the paper P and the thickness direction of the paper P.

According to the present exemplary embodiment, the lower image reading unit 222 reads the image of a read portion 98, which is a portion located at a predetermined reading area of the transported paper P.

According to the present exemplary embodiment, the reflected light from the read portion 98, which is generated as the light from the light source 225 (see FIG. 1) is radiated to the paper P, is directed to the light receiving unit 226.

Thus, the lower image reading unit 222 reads the image of the read portion 98 of the paper P.

According to the present exemplary embodiment, the protruding portion 610 is provided at an area deviated from the width-direction plane 432 along the optical axis 430 of the reflected light from the read portion 98 toward the light receiving unit 226.

The protruding portion 610 is located upstream of the width-direction plane 432 in the moving direction of the transported paper P.

According to the present exemplary embodiment, when the positions in the moving direction of the paper P, which is transported and moved to the downstream side, are compared, the protruding portion 610 is located upstream of the width-direction plane 432.

Here, when the protruding portion 610 is on the width-direction plane 432, the protruding portion 610 is located behind the paper P and behind the read portion 98 of the paper P.

In this case, the protruding portion 610 may affect the reading of the read portion 98 by the lower image reading unit 222, and the quality of the read image obtained by the lower image reading unit 222 may deteriorate.

On the other hand, as in the present exemplary embodiment, when the protruding portion 610 is provided at an area deviated from the width-direction plane 432, the effect of the protruding portion 610 on the reading of the read portion 98 is reduced.

According to the present exemplary embodiment, when the upper rotary body 51 rotates from the state illustrated in FIG. 5, the protruding portion 610 enters a state of being located at an area deviated from the gap 420.

More specifically, when the upper rotary body 51 rotates and the reading guide surface 51G enters a state of not facing the lower image reading unit 222, the protruding portion 610 enters a state of being located at an area deviated from the gap 420.

When the upper rotary body 51 rotates and, for example, the transport guide surface 51M enters a state of facing the lower image reading unit 222, the protruding portion 610 enters a state of being located at an area deviated from the gap 420.

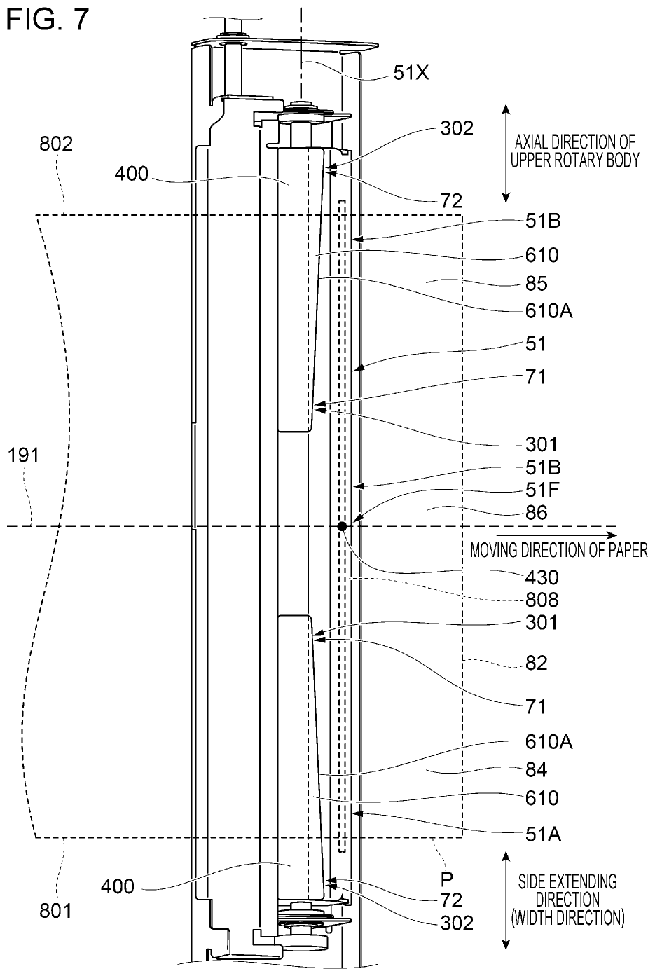

FIG. 7 is a diagram when the upper rotary body 51 is viewed from below the upper rotary body 51 and from the direction indicated by arrow VII in FIG. 5. Further, FIG. 7 also illustrates the transported paper P.

According to the present exemplary embodiment, as illustrated in FIG. 7, the rotation axis 51X of the upper rotary body 51 extends along a side extending direction that is an extending direction of a leading end side 82, which is a side located at the leading end of the paper P transported and moved to the downstream side. The side extending direction matches the above-described “width direction of the paper P”.

The paper P according to the present exemplary embodiment is formed in a rectangular shape and has four sides, and according to the present exemplary embodiment, the rotation axis 51X of the upper rotary body 51 extends along the side extending direction that is the extending direction of the leading end side 82, which is one side of the four sides.

In other words, according to the present exemplary embodiment, the rotation axis 51X of the upper rotary body 51 extends along the width direction of the paper P.

Further, according to the present exemplary embodiment, the protruding portion 610 extends in the axial direction of the upper rotary body 51. In other words, according to the present exemplary embodiment, the protruding portion 610 extends in the side extending direction, which is the extending direction of the leading end side 82 of the paper P.

According to the present exemplary embodiment, as described above and as illustrated in FIG. 7, the protruding portions 610 are provided on the one end portion 51A and the other end portion 51B of the upper rotary body 51 in the axial direction.

Therefore, according to the present exemplary embodiment, the protruding portions 610 are not in contact with the entire area of the paper P in the side extending direction, but are in contact with a part of the entire area.

Specifically, the protruding portions 610 are in contact with both one end portion 84 and the other end portion 85 of the paper P in the side extending direction. The protruding portions 610 are not in contact with a central portion 86 of the paper P in the side extending direction.

The protruding portions 610 are not in contact with the entire area of the paper P in the width direction of the paper P. The protruding portions 610 are in contact with the one end portion 84 and the other end portion 85 of the paper P in the side extending direction.

As in the present exemplary embodiment, in the configuration in which the protruding portions 610 are in contact with a part of the entire area of the paper P in the side extending direction, the load applied to the paper P from the protruding portions 610 is reduced, and thus jams of the paper P are less likely to occur.

When the load applied to the paper P from the protruding portions 610 is large, the paper P is unlikely to move, which may cause jams of the paper P.

According to the present exemplary embodiment, the contact area between the paper P and the protruding portions 610 is reduced, and the load applied to the paper P is reduced, and thus jams of the paper P are less likely to occur.

Furthermore, instead of excluding the configuration in which the protruding portions 610 are in contact with the entire area of the paper P in the side extending direction, for example, the protruding portions 610 may be provided in the entire area of the upper rotary body 51 in the axial direction, and the protruding portions 610 may be in contact with the entire area of the paper P in the side extending direction.

However, in this case, the protrusion amount of the protruding portion 610 (not illustrated) located at the central portion 51F of the upper rotary body 51 in the axial direction is preferably smaller than the protrusion amounts of the protruding portions 610 located at the one end portion 51A and the other end portion 51B of the upper rotary body 51 in the axial direction.

As illustrated in FIG. 7, each of the protruding portions 610 extends in the axial direction of the upper rotary body 51.

Furthermore, according to the present exemplary embodiment, the elastic body 400 is formed like a plate and, accordingly, the protruding portion 610 configurated by a part of the elastic body 400 is also formed like a plate.

The two protruding portions 610 provided on the one end portion 51A and the other end portion 51B of the upper rotary body 51, respectively, includes the edge portions 610A extending in the axial direction of the upper rotary body 51 at the leading ends in the protruding direction.

The edge portion 610A provided in each of the protruding portions 610 includes one part 71 and the other part 72.

The one part 71 is located at one end portion 301 of the edge portion 610A in the extending direction and on the side closer to the central portion 51F of the upper rotary body 51 in the axial direction.

The other part 72 is located at the other end portion 302 in the extending direction of the edge portion 610A and on the side farther from the central portion 51F of the upper rotary body 51.

According to the present exemplary embodiment, the position of the one part 71 of the edge portion 610A in the extending direction of the edge portion 610A is different from the position of the other part 72 of the edge portion 610A in the extending direction of the edge portion 610A.

Here, the “extending direction of the edge portion 610A” is synonymous with a direction perpendicular to the protruding direction of the protruding portion 610. Furthermore, the “extending direction of the edge portion 610A” may also be said to be the longitudinal direction of the edge portion 610A.

As illustrated in FIG. 6, in each of the protruding portions 610, the protrusion amount of the one part 71 of the edge portion 610A is smaller than the protrusion amount of the other part 72 of the edge portion 610A.

In each of the protruding portions 610, the one part 71 of the edge portion 610A is located on the side farther from the lower image reading unit 222 (not illustrated in FIG. 6) than the other part 72 of the edge portion 610A.

According to the present exemplary embodiment, the one part 71 located on the side closer to the central portion 51F of the upper rotary body 51 is located on the side farther from the lower image reading unit 222 than the other part 72 located on the side farther from the central portion 51F.

Furthermore, according to the present exemplary embodiment, as illustrated in FIG. 6, the edge portion 610A of each of the protruding portions 610 is provided in an inclined state to become gradually farther from the lower image reading unit 222 as the edge portion 610A extends from the other part 72 to the one part 71.

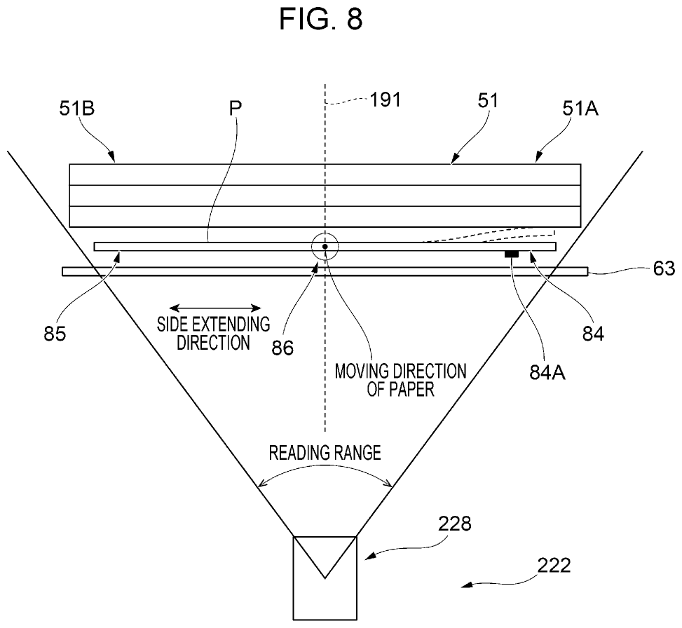

FIG. 8 is a diagram illustrating an image reading range by the lower image reading unit 222. FIG. 8 illustrates a state where the lower image reading unit 222, and the like, are viewed from the downstream side in the transport direction of the paper P.

Here, it is assumed that the one end portion 84 of the paper P in the side extending direction is displaced in the thickness direction of the paper P while the paper P is passing through the position facing the light transmission unit 63.

In this case, on the read image obtained by the reading of the lower image reading unit 222, an image 84A formed at the end portion moves in the main scanning direction.

According to the present exemplary embodiment, as illustrated in FIG. 1, the imaging optical system 228 such as a lens is provided.

According to the present exemplary embodiment, as illustrated in FIG. 8, the image formed on the paper P located within the reading range gradually expanding along the width direction of the paper P from the imaging optical system 228 is read.

According to the present exemplary embodiment, the lower image reading unit 222 uses the reduction optical system to collect the reflected light from the paper Ponto the light receiving unit 226 (see FIG. 1) and read the image located within the reading range out of the images formed on the paper P.

According to the present exemplary embodiment, when the lower image reading unit 222 reads the image, image reading is performed on the image in a band-like region 808 that is a band-like region extending from one lateral side 801 (see FIG. 7) to the other lateral side 802 of the paper P out of the image formed on the paper P.

As illustrated in FIG. 7, the paper P includes the one lateral side 801 and the other lateral side 802 that are located at different positions in the width direction of the paper P and extend along the moving direction of the paper P.

According to the present exemplary embodiment, the image located within the band-like region 808 extending from the one lateral side 801 to the other lateral side 802 is read out of the images formed on the paper P.

According to the present exemplary embodiment, as described above, the reduction optical system is used.

In this case, the reflected light from the portion of the paper P located within the band-like region 808 is directed toward the light receiving unit 226 (see FIG. 1) having a length smaller than the separation distance between the one lateral side 801 and the other lateral side 802.

According to the present exemplary embodiment, the length of the light receiving unit 226 in the side extending direction is smaller than the separation distance between the one lateral side 801 and the other lateral side 802.

According to the present exemplary embodiment, the reflected light from the image present between the one lateral side 801 and the other lateral side 802 is collected onto the light receiving unit 226 by using the reduction optical system, and the image is read.

According to the present exemplary embodiment, as illustrated in FIG. 8, when the one end portion 84 in the side extending direction of the paper P is displaced in the thickness direction of the paper P as indicated by a broken line, the image 84A formed on this end portion is also displaced in the thickness direction of the paper P.

In this case, on the read image obtained by reading of the lower image reading unit 222, the image 84A moves in the main scanning direction and to the center portion side of the read image.

In this case, although the position of the image 84A with respect to the paper P is not changed, the position of the image 84A is changed on the read image. In this case, the quality of the read image obtained by the lower image reading unit 222 is reduced.

Also, as for the image formed at the other end portion 85 in the side extending direction of the paper P, although not illustrated, when the other end portion 85 is displaced in the thickness direction of the paper P, the position of the image formed at the other end portion 85 is changed on the read image.

In this case, also, the quality of the read image obtained by the lower image reading unit 222 is reduced.

On the other hand, according to the present exemplary embodiment, the protruding portions 610 are provided in a form of corresponding to the one end portion 84 and the other end portion 85 in the side extending direction of the paper P.

In this case, the displacement of the one end portion 84 and the other end portion 85 is suppressed. Accordingly, according to the present exemplary embodiment, a reduction in the quality of the read image is suppressed.

The center portion 86 of the paper P (see FIG. 8), which is located at the center portion in the side extending direction, is located at the center portion in the longitudinal direction of the reading range.

In this case, even when the central portion 86 moves in the thickness direction of the paper P, the image formed on the central portion 86 does not move on the read image, or the amount of movement is small.

According to the present exemplary embodiment, the contact area between the paper P and the protruding portions 610 (not illustrated in FIG. 8) is reduced so that the load applied to the paper P is reduced.

For this reduction, according to the present exemplary embodiment, the load applied to the paper P is reduced with the configuration in which the protruding portions 610 are not in contact with a portion of the paper P located in the central portion 86 in the longitudinal direction of the reading range.

According to the present exemplary embodiment, the load applied to the paper P is reduced with the configuration in which the protruding portions 610 are not in contact with the central portion 86 of the paper P where the effect on the read image is small even when the central portion 86 moves in the thickness direction of the paper P.

As a result, according to the present exemplary embodiment, it is possible to reduce the load applied to the paper P while suppressing a reduction in the quality of the read image obtained by the lower image reading unit 222.

According to the present exemplary embodiment, as illustrated in FIG. 7, the one end portion 51A and the other end portion 51B of the upper rotary body 51 in the axial direction are located at areas deviated from the optical axis 430 of the reflected light.

Further, according to the present exemplary embodiment, the protruding portions 610 provided at the one end portion 51A and the other end portion 51B are also located at areas deviated from the optical axis 430 of the reflected light.

Here, as illustrated in FIGS. 7 and 8, a virtual plane 191 (hereinafter referred to as the “moving-direction plane 191”) is assumed, which extends along the optical axis 430 of the reflected light and extends along the moving direction of the moving paper P.

According to the present exemplary embodiment, the one end portion 51A and the other end portion 51B of the upper rotary body 51 in the axial direction are located at areas different from the moving-direction plane 191 and are located at areas deviated from the moving-direction plane 191.

In this case, when the one end portion 84 of the paper P (see FIG. 8), which is a facing portion located at the position facing the one end portion 51A of the upper rotary body 51, is displaced in the thickness direction of the paper P, the quality of the read image obtained by the lower image reading unit 222 is reduced.

Similarly, when the other end portion 85 of the paper P, which is a facing portion located at the position facing the other end portion 51B of the upper rotary body 51, is displaced in the thickness direction of the paper P, the quality of the read image obtained by the lower image reading unit 222 is reduced.

Therefore, according to the present exemplary embodiment, in order to suppress the reduction in the quality of the read image, as illustrated in FIG. 7 and the like, the protruding portions 610 are provided at the one end portion 51A and the other end portion 51B of the upper rotary body 51 so that the displacement of the above-described facing portion in the thickness direction of the paper P is suppressed.

According to the present exemplary embodiment, the protruding portion 610 is provided at a portion of the upper rotary body 51 located at an area deviated from the moving-direction plane 191, and the displacement of a portion of the paper P located at an area deviated from the moving-direction plane 191 in the thickness direction of the paper P is suppressed.

In other words, according to the present exemplary embodiment, in order to suppress a reduction in the quality of the read image, the protruding portions 610 are provided at the one end portion 51A and the other end portion 51B of the upper rotary body 51 located at areas deviated from the optical axis 430 of the reflected light so that the displacement of the above-described facing portions in the thickness direction of the paper P is suppressed.

In this case, the displacement of the facing portion in the thickness direction of the paper P is suppressed, and a reduction in the quality of the read image obtained by the lower image reading unit 222 is suppressed.

According to the present exemplary embodiment, as illustrated in FIG. 7, the protruding portions 610 are in contact with the one end portion 84 and the other end portion 85 of the paper P whose positions in the side extending direction are different from each other.

In this case, the displacement of the one end portion 84 and the other end portion 85 in the thickness direction of the paper P is suppressed.

Thus, as described above, the movement of the image on the read image is suppressed, and the reduction in the quality of the read image obtained by the lower image reading unit 222 is suppressed.

Furthermore, according to the present exemplary embodiment, as illustrated in FIG. 7, when the optical axis 430 of the reflected light is used as a reference, the other part 72 of the edge portion 610A is located on the side farther from the optical axis 430 than the one part 71 of the edge portion 610A.

Further, according to the present exemplary embodiment, as illustrated in FIG. 7, when the moving-direction plane 191 is used as a reference, the other part 72 of the edge portion 610A is located on the side farther from the moving-direction plane 191 than the one part 71 of the edge portion 610A.

According to the present exemplary embodiment, as illustrated in FIG. 7, the other part 72 of the edge portion 610A, which is located farther from the optical axis 430, protrudes further than the one part 71 of the edge portion 610A.

In this case, the other part 72 is located closer to the lower image reading unit 222 than the one part 71.

In other words, according to the present exemplary embodiment, the one part 71 located closer to the optical axis 430 is located on the side farther from the lower image reading unit 222 than the other part 72.

According to the present exemplary embodiment, a portion closer to a lateral side, which is a side along the moving direction of the paper P among the sides of the paper P, is located farther from the optical axis 430.

In this case, for example, even when the lateral side portion of the paper P, which is the portion at which the lateral side is located, is slightly moved in the thickness direction of the paper P, the movement may affect the read image and cause a reduction in the quality of the read image.

On the other hand, an inner portion of the paper P, which is a portion located on the inner side than the lateral side, is located on the side closer to the optical axis 430. Even when the inner portion is moved in the thickness direction of the paper P, the effect on the read image is small.

According to the present exemplary embodiment, as described above, the other part 72 located farther from the optical axis 430 protrudes further than the one part 71, and the other part 72 is located closer to the lower image reading unit 222 than the one part 71.

In this case, it is possible to more effectively suppress the movement of the above-described lateral side portion in the thickness direction of the paper P.

Furthermore, as in the present exemplary embodiment, in the configuration in which the one part 71 located closer to the optical axis 430 is located on the side farther from the lower image reading unit 222 than the other part 72, it is possible to reduce the load applied to the paper P while suppressing a reduction in the quality of the obtained read image.

Here, when the protrusion amount of the other part 72 and the protrusion amount of the one part 71 are the same and the protrusion amounts are large, the movement of the above- described lateral side portion in the thickness direction of the paper P is suppressed.

However, in this case, the load applied to the paper P increases.

Furthermore, when the protrusion amount of the other part 72 and the protrusion amount of the one part 71 are the same and the protrusion amounts are small, the load applied to the paper P is small.

However, in this case, the above-described lateral side portion is likely to move in the thickness direction of the paper P, which is likely to cause a reduction in the quality of the read image.

With the configuration in which the other part 72 protrudes further than the one part 71, the load applied to the paper P may be reduced while a reduction in the quality of the read image is suppressed.

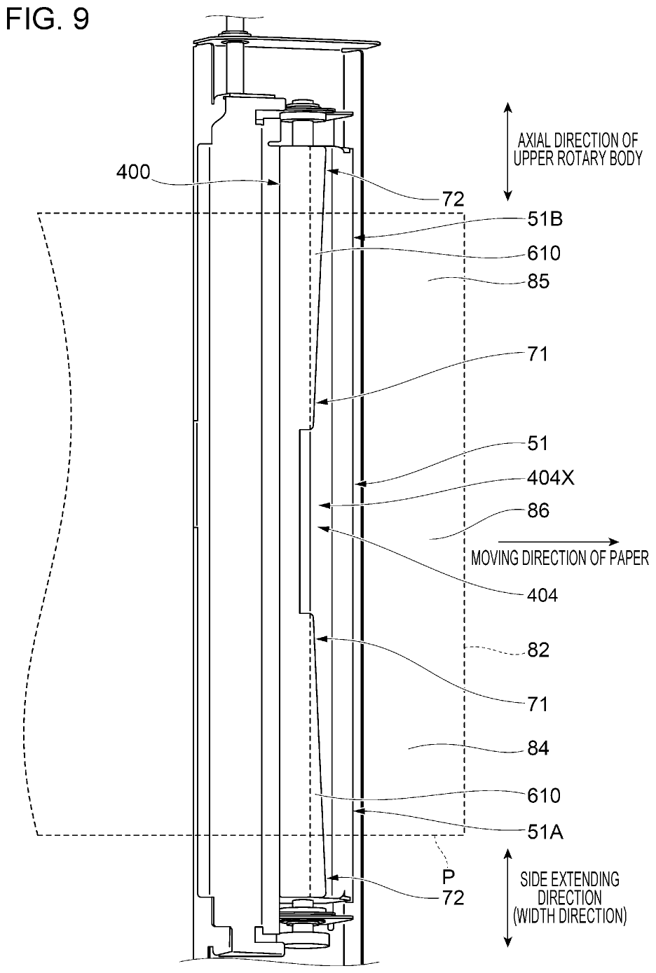

FIG. 9 is a diagram illustrating a modification of the elastic body 400.

In the configuration example described above, the two elastic bodies 400 are provided so that the protruding portions 610 corresponding to the one end portion 84 and the other end portion 85, respectively, in the side extending direction of the paper P are provided.

In the modification illustrated in FIG. 9, the one elastic body 400 includes the protruding portions 610 corresponding to the one end portion 84 and the other end portion 85, respectively, in the side extending direction of the paper P.

According to the modification, the one elastic body 400 includes the protruding portions 610 at the areas corresponding to the one end portion 84 and the other end portion 85, respectively, in the side extending direction of the paper P.

In other words, according to the modification, in the one elastic body 400, the protruding portions 610 are provided at the areas corresponding to the one end portion 51A and the other end portion 51B, respectively, of the upper rotary body 51.

Furthermore, according to the modification, a cutout 404 is provided at a central portion 404X of the one elastic body 400 in the longitudinal direction.

Thus, according to the modification, the protruding portion 610 is not provided at an area of the one elastic body 400 corresponding to the central portion 86 in the side extending direction of the paper P.

Furthermore, according to the modification, similarly to the above, in each of the protruding portions 610, the other part 72 is located on the side closer to the lower image reading unit 222 (not illustrated in FIG. 9) than the one part 71.

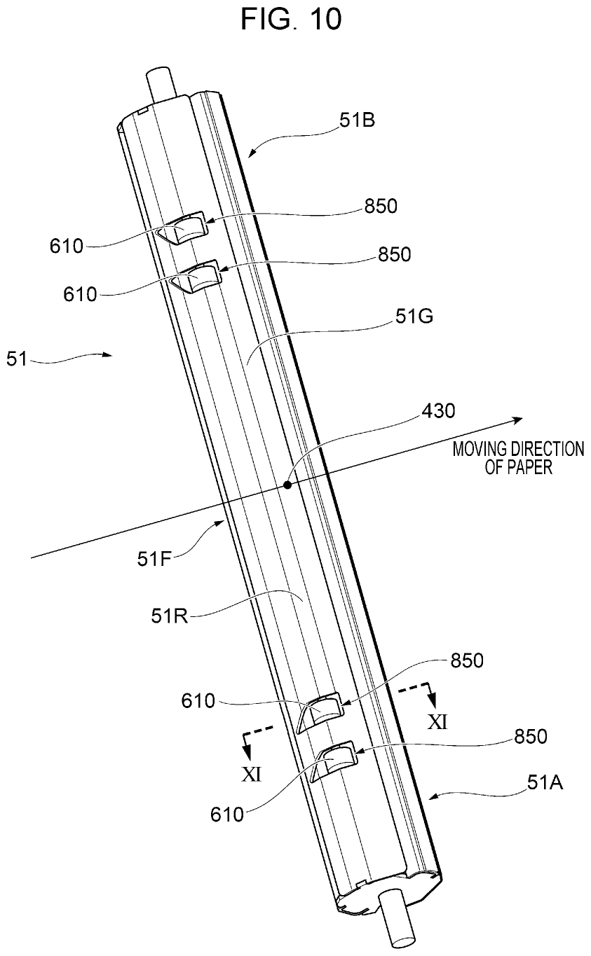

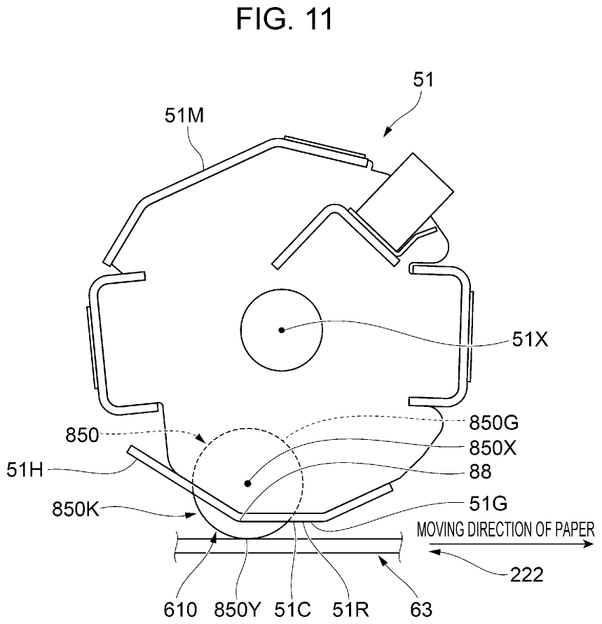

FIG. 10 is a diagram illustrating another configuration example of the upper rotary body 51. FIG. 11 is a cross-sectional view of the upper rotary body 51 taken along line XI-XI of FIG. 10.

FIG. 10 illustrates a state in which the upper rotary body 51 is viewed from the reading guide surface 51G side. FIG. 11 illustrates a cross-section of the upper rotary body 51 at the area where a rotary member (described below) is provided.

In the configuration example illustrated in FIGS. 10 and 11, similarly to the above and as illustrated in FIG. 10, the protruding portions 610 are provided on the one end portion 51A and the other end portion 51B of the upper rotary body 51.

The protruding portion 610 is configurated by a rotary member 850 attached to the upper rotary body 51.

Each of the rotary members 850 rotates about a rotation axis 850X (see FIG. 11) extending along the axial direction of the upper rotary body 51.

As illustrated in FIG. 10, the plurality of rotary members 850 is provided at each of the one end portion 51A and the other end portion 51B of the upper rotary body 51.

Specifically, the two rotary members 850 are provided at each of the one end portion 51A and the other end portion 51B of the upper rotary body 51. The number of the rotary members 850 is not limited to two, but may be three or more.

In this configuration example, the protruding portion 610 is configurated by the rotary member 850, and similarly to the above, the protruding portions 610 are provided at each of the one end portion 51A and the other end portion 51B of the upper rotary body 51.

The plurality of protruding portions 610 is provided at each of the one end portion 51A and the other end portion 51B of the upper rotary body 51.

The plurality of rotary members 850 provided at each of the one end portion 51A and the other end portion 51B of the upper rotary body 51 is provided in a form of being arranged side by side in the axial direction of the upper rotary body 51.

In other words, the plurality of protruding portions 610 provided at each of the one end portion 51A and the other end portion 51B of the upper rotary body 51 is provided in a form of being arranged side by side in the axial direction of the upper rotary body 51.

Also in this configuration example, the protruding portion 610 configurated by the rotary member 850 is provided at an area deviated from the optical axis 430 of the reflected light.

In other words, also in this configuration example, the protruding portion 610 configurated by the rotary member 850 is provided at an area deviated from the moving-direction plane 191 (not illustrated in FIGS. 10 and 11, see FIG. 8).

Further, also in this configuration example, as illustrated in FIG. 11, the protruding portion 610 configurated by the rotary member 850 protrudes from the upper rotary body 51 toward the lower image reading unit 222.

Similarly to the above, also in this configuration example, as illustrated in FIG. 11, when the reading guide surface 51G enters a state of facing the lower image reading unit 222, the protruding portion 610 configurated by the rotary member 850 protrudes toward the lower image reading unit 222.

In this configuration example, a portion of the rotary member 850 that protrudes from the outer peripheral surface 51R of the upper rotary body 51 is the protruding portion 610.

As illustrated in FIG. 11, each of the rotary members 850 configurating the protruding portions 610 is provided at the joint portion 88 between the reading guide surface 51G and the upstream guide surface 51H.

Here, the phrase “provided at the joint portion 88” refers to a state where, when the joint portion 88 and the rotary member 850 are projected in the axial direction of the upper rotary body 51 and on a virtual plane (not illustrated) perpendicular to the axial direction, the joint portion 88 is located further inside than an outer peripheral surface 850G of the rotary member 850.

According to the present exemplary embodiment, as described above, when image reading by the lower image reading unit 222 is performed, the reading guide surface 51G, which is an example of the one plane surface 51C, faces the lower image reading unit 222.

Furthermore, according to the present exemplary embodiment, as described above, when the reading guide surface 51G enters a state of facing the lower image reading unit 222, the upstream guide surface 51H is located upstream of the reading guide surface 51G in the moving direction of the paper P.

Each of the rotary members 850 is provided at the joint portion 88 between the reading guide surface 51G and the upstream guide surface 51H.

Further, in the configuration example illustrated in FIGS. 10 and 11, each of the rotary members 850 is provided in a form that a part thereof protrudes from the outer peripheral surface 51R of the upper rotary body 51, as illustrated in FIG. 11.

According to the present exemplary embodiment, an outer peripheral portion 850K of the rotary member 850 is configurated to protrude from the outer peripheral surface 51R of the upper rotary body 51. According to the present exemplary embodiment, the outer peripheral portion 850K of the rotary member 850 serves as the protruding portion 610 that protrudes from the upper rotary body 51 toward the lower image reading unit 222.

Also in this configuration example, similarly to the above, when the paper P is transported from the upstream side, the paper P is guided by the protruding portion 610 configurated by the rotary member 850.

Furthermore, in this configuration example, when the paper P is transported from the upstream side, the rotary member 850 rotates by the force applied to the rotary member 850 from the paper P in contact with the rotary member 850.

When the rotary member 850 rotates, the load applied to the paper P is smaller than that when the rotary member 850 does not rotate.

In this configuration example, as described above, the rotation axis 850X of the rotary member 850 extends along the axial direction of the upper rotary body 51.

In this case, when the rotary member 850 rotates, a contact portion 850Y of the rotary member 850, which is a portion in contact with the paper P, moves to the downstream side in the moving direction of the paper P.

In this case, the load applied to the paper P is smaller than that in a case where the contact portion 850Y moves, for example, in a direction intersecting the moving direction of the paper P.

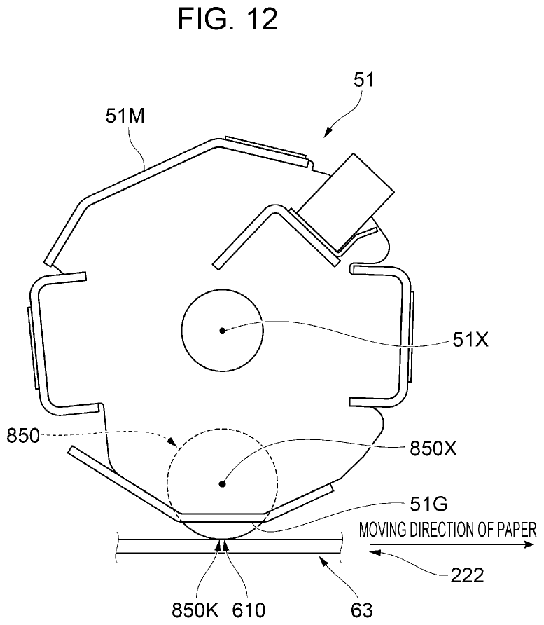

FIG. 12 is a diagram illustrating another configuration example of the upper rotary body 51.

In this configuration example, the rotary member 850 is provided in a form that a part thereof protrudes from the reading guide surface 51G.

Although not illustrated, also in this configuration example, similarly to the above, the plurality of rotary members 850 is provided on each of the one end portion 51A and the other end portion 51B of the upper rotary body 51 in the axial direction.

As described above, according to the present exemplary embodiment, when the lower image reading unit 222 reads an image, the reading guide surface 51G faces the lower image reading unit 222.

In the configuration example illustrated in FIG. 12, the rotary member 850 is provided in a form that a part thereof protrudes from the reading guide surface 51G facing the lower image reading unit 222.

In other words, in this configuration example, the outer peripheral portion 850K of the rotary member 850 is configurated to protrude from the reading guide surface 51G.

Also in this configuration example, similarly to the above, when the paper P is transported from the upstream side to the upper rotary body 51, the paper P is guided by the rotary member 850 serving as the protruding portion 610.

Furthermore, when the paper P is transported from the upstream side to the upper rotary body 51, the rotary member 850 rotates by receiving a force from the paper P.

In the configuration examples illustrated in FIGS. 10 to 12, the rotary member 850 is configurated to be in contact with the lower image reading unit 222. Specifically, the rotary member 850 is configurated to be in contact with the light transmission unit 63 of the lower image reading unit 222.

However, this is not a limitation, and a configuration may be adopted in which the rotary member 850 and the lower image reading unit 222 are not in contact with each other.

In a configuration in which the rotary member 850 and the lower image reading unit 222 are not in contact with each other, the load on the paper P passing between the rotary member 850 and the lower image reading unit 222 is further reduced.

Further, although description has been omitted above, the upper rotary body 51 is provided with an elastic member that biases the rotary member 850 toward the lower image reading unit 222 side. Thus, according to the present exemplary embodiment, the rotary member 850 is movable to the rotation axis 51X side of the upper rotary body 51.

According to the present exemplary embodiment, when the rotary member 850 passes through the position facing the light transmission unit 63 while being in contact with the light transmission unit 63 with the rotation of the upper rotary body 51, the rotary member 850 moves to the rotation axis 51X side of the upper rotary body 51 against the force from the elastic member.

In the configuration examples illustrated in FIGS. 10 to 12, the rotary member 850 is not provided at the central portion 51F (see FIG. 10) of the upper rotary body 51 in the axial direction.

According to the present exemplary embodiment, assuming virtual planes (not illustrated) extending along the moving direction of the paper P and passing through the respective rotary members 850, these virtual planes are configurated not to pass through the optical axis 430 of the reflected light.

In other words, also in the configuration examples illustrated in FIGS. 10 to 12, the rotary member 850 is not provided on the above-described moving-direction plane 191 (see FIG. 8), and the rotary member 850 is provided at an area deviated from the moving-direction plane 191.

Each of the rotary members 850 does not need to be provided at both the one end portion 51A and the other end portion 51B of the upper rotary body 51, and the rotary member 850 may be provided at only one end portion out of the one end portion 51A and the other end portion 51B.

In other words, the protruding portion 610 configurated by the rotary member 850 may be provided at only any one end portion out of the one end portion 51A and the other end portion 51B of the upper rotary body 51.

Furthermore, the rotary member 850 (hereinafter, referred to as the “central rotary member 850”) may be provided at the central portion 51F (see FIG. 10) of the upper rotary body 51 in the axial direction.

Further, when the central rotary member 850 is provided at the central portion 51F, the central rotary member 850 may be provided on the moving-direction plane 191 (not illustrated in FIG. 10) (see FIG. 8).

Furthermore, when the central rotary member 850 is provided at the upper rotary body 51, the protrusion amount of the central rotary member 850 from the outer peripheral surface 51R of the upper rotary body 51 is preferably smaller than the protrusion amount of the end-portion rotary member 850 from the outer peripheral surface 51R of the upper rotary body 51.

Here, the “end-portion rotary member 850” refers to the above-described rotary member 850 provided at the one end portion 51A (see FIG. 10) or the other end portion 51B of the upper rotary body 51.

In other words, the “end-portion rotary member 850” refers to the rotary members 850 illustrated in FIGS. 10 to 12.

When the protrusion amount of the central rotary member 850 is smaller than the protrusion amount of the end-portion rotary member 850, for example, the outer diameter of the central rotary member 850 is smaller than the outer diameter of the end-portion rotary member 850

Accordingly, the protrusion amount of the central rotary member 850 is smaller than the protrusion amount of the end-portion rotary member 850.

In addition, for example, the central rotary member 850 may be provided on the side closer to the rotation axis 51X (see FIG. 11), which is the axial center of the upper rotary body 51, than the end-portion rotary member 850.

Also in this case, the protrusion amount of the central rotary member 850 is smaller than the protrusion amount of the end-portion rotary member 850.

In addition, the outer diameter of the central rotary member 850 may be smaller than the outer diameter of the end-portion rotary member 850, and the central rotary member 850 may be provided on the side closer to the rotation axis 51X of the upper rotary body 51 than the end-portion rotary member 850.

Furthermore, when the end-portion rotary member 850 is provided at least at one end portion out of the one end portion 51A and the other end portion 51B of the upper rotary body 51, only the one end-portion rotary member 850 may be provided at the one end portion without providing the plurality of end-portion rotary members 850.

In addition, when the plurality of end-portion rotary members 850 is provided at least at one end portion of the upper rotary body 51, the protrusion amount of the end-portion rotary member 850 located on the side closer to the central portion 51F (see FIG. 10) of the upper rotary body 51 in the axial direction may be smaller than the protrusion amount of the end-portion rotary member 850 located on the side farther from the central portion 51F.

The “protrusion amount” here refers to the protrusion amount of the end-portion rotary member 850 from the outer peripheral surface 51R of the upper rotary body 51.

When the protrusion amount of the end-portion rotary member 850 located on the side closer to the central portion 51F is smaller than the protrusion amount of the end-portion rotary member 850 located on the side farther from the central portion 51F, for example, the outer diameter of the end-portion rotary member 850 located on the side closer to the central portion 51F is smaller than the outer diameter of the end-portion rotary member 850 located on the side farther from the central portion 51F.

Accordingly, the protrusion amount of the end-portion rotary member 850 located on the side closer to the central portion 51F is smaller than the protrusion amount of the end-portion rotary member 850 located on the side farther from the central portion 51F.

In addition, the end-portion rotary member 850 located on the side closer to the central portion 51F may be provided on the side closer to the rotation axis 51X (see FIG. 11) of the upper rotary body 51 than the end-portion rotary member 850 located on the side farther from the central portion 51F.

Thus, the protrusion amount of the end-portion rotary member 850 located on the side closer to the central portion 51F is also smaller than the protrusion amount of the end-portion rotary member 850 located on the side farther from the central portion 51F.

In addition, the outer diameter of the end-portion rotary member 850 located on the side closer to the central portion 51F may be smaller than the outer diameter of the end-portion rotary member 850 located on the side farther from the central portion 51F, and the end-portion rotary member 850 located on the side closer to the central portion 51F may be provided on the side closer to the rotation axis 51X of the upper rotary body 51 than the end-portion rotary member 850 located on the side farther from the central portion 51F.

### APPENDIX

### (((1)))

An image reading device comprising:
a transport section that transports a recording medium along a transport path;
an image reading section that is provided on one side of the transport path and reads an image formed on the recording medium transported through the transport path;
a rotary body that is rotatably provided and is provided on a side opposite to an installation side of the image reading section across the transport path; and
a protruding portion that is provided at least at one end portion out of one end portion and the other end portion of the rotary body in an axial direction and protrudes from the rotary body toward the image reading section side.

### (((2)))

The image reading device according to (((1))), wherein the protruding portion is provided at both the one end portion and the other end portion of the rotary body.

### (((3)))

The image reading device according to (((1))) or (((2))), wherein the protruding portion is not provided at a central portion of the rotary body in the axial direction.

### (((4)))

The image reading device according to any of (((1)) to ((3))), wherein when a specific portion of an outer peripheral surface of the rotary body is in a state of facing the image reading section, the protruding portion is in a state of protruding toward the image reading section side.

### (((5))

The image reading device according to any of (((1))) to ((4))), wherein the protruding portion is provided in a non-contact state with the image reading section and is provided in a state of having a gap with the image reading section.

### (((6)))

The image reading device according to any of (((1))) to (((5))), wherein
the protruding portion is formed like a plate and has an edge portion extending in the axial direction of the rotary body at a leading end in a protruding direction, and
one part of the edge portion is located on a side farther from the image reading section than the other part whose position in an extending direction of the edge portion is different from a position of the one part.

### (((7)))

The image reading device according to (((6))), wherein
the one part of the edge portion is located on a side closer to a central portion of the rotary body in the axial direction than the other part, and
the one part located on a side closer to the central portion of the rotary body is located on a side farther from the image reading section than the other part.

### (((8)))

The image reading device according to (((7))), wherein the edge portion of the protruding portion is provided to become gradually farther from the image reading section as the edge portion extends from the other part to the one part.

### (((9)))

The image reading device according to (((6))), wherein
the image reading section uses a reduction optical system to collect reflected light from the recording medium onto a light receiving unit and read an image on the recording medium, and
when an optical axis of the reflected light directed from the recording medium to the light receiving unit is used as a reference, the other part of the edge portion is located on a side farther from the optical axis than the one part.

### (((10)))

The image reading device according to any of (((1))) to (((5))), wherein the protruding portion is configurated by a rotary member attached to the rotary body.

### (((11)))

The image reading device according to (((10))), wherein the rotary member rotates about a rotation axis extending along the axial direction of the rotary body.

### (((12)))

The image reading device according to (((10))) or (((11))), wherein
an outer surface of the rotary body includes a plurality of plane surfaces whose positions in a circumferential direction of the rotary body are different from each other,
when the image reading section reads the image, one plane surface out of the plurality of plane surfaces faces the image reading section, and
the rotary member is provided in a form that a part of the rotary member protrudes from the one plane surface.

### (((13)))

The image reading device according to (((10))) or (((11))), wherein
an outer surface of the rotary body includes a plurality of plane surfaces whose positions in a circumferential direction of the rotary body are different from each other,
when the image reading section reads the image, one plane surface out of the plurality of plane surfaces faces the image reading section, and the other plane surface next to the one plane surface is located upstream of the one plane surface in a moving direction of the recording medium, and
the rotary member configurating the protruding portion is provided at a joint portion between the one plane surface and the other plane surface.

### (((14)))

An image reading device comprising:
a transport section that transports a recording medium along a transport path;
an image reading section that is provided on one side of the transport path and uses a reduction optical system to collect reflected light from the recording medium onto a light receiving unit and read an image formed on the recording medium;
a rotary body that is rotatably provided and is provided on a side opposite to an installation side of the image reading section across the transport path; and
a protruding portion that is provided on the rotary body, is provided at least at an area deviated from an optical axis of the reflected light directed from the recording medium to the light receiving unit, and protrudes from the rotary body toward the image reading section side.

### (((15)))

The image reading device according to (((14))), wherein the protruding portion is configurated by a rotary member or a plate-like elastic body.

### (((16)))

The image reading device according to (((15))), wherein the rotary member rotates about a rotation axis extending along the axial direction of the rotary body.

### (((17)))

An image forming system comprising:
an image forming section that forms an image on a recording medium; and
an image reading device that reads the image formed on the recording medium by the image forming section, wherein
the image reading device is configurated by including the image reading device according to any of (((1))) to (((16))).

What is claimed is:

1. An image reading device comprising:
a transport section that transports a recording medium along a transport path;
an image reading section that is provided on one side of the transport path and reads an image formed on the recording medium transported through the transport path;
a rotary body that is rotatably provided and is provided on a side opposite to an installation side of the image reading section across the transport path; and
a protruding portion that is provided at least at one end portion out of one end portion and the other end portion of the rotary body in an axial direction and protrudes from the rotary body toward the image reading section side.

2. The image reading device according to claim 1, wherein the protruding portion is provided at both the one end portion and the other end portion of the rotary body.

3. The image reading device according to claim 1, wherein the protruding portion is not provided at a central portion of the rotary body in the axial direction.

4. The image reading device according to claim 1, wherein when a specific portion of an outer peripheral surface of the rotary body is in a state of facing the image reading section, the protruding portion is in a state of protruding toward the image reading section side.

5. The image reading device according to claim 1, wherein the protruding portion is provided in a non-contact state with the image reading section and is provided in a state of having a gap with the image reading section.

6. The image reading device according to claim 1, wherein
the protruding portion is formed like a plate and has an edge portion extending in the axial direction of the rotary body at a leading end in a protruding direction, and
one part of the edge portion is located on a side farther from the image reading section than the other part whose position in an extending direction of the edge portion is different from a position of the one part.

7. The image reading device according to claim 6, wherein
the one part of the edge portion is located on a side closer to a central portion of the rotary body in the axial direction than the other part, and
the one part located on a side closer to the central portion of the rotary body is located on a side farther from the image reading section than the other part.

8. The image reading device according to claim 7, wherein the edge portion of the protruding portion is provided to become gradually farther from the image reading section as the edge portion extends from the other part to the one part.

9. The image reading device according to claim 6, wherein
the image reading section uses a reduction optical system to collect reflected light from the recording medium onto a light receiving unit and read an image on the recording medium, and
when an optical axis of the reflected light directed from the recording medium to the light receiving unit is used as a reference, the other part of the edge portion is located on a side farther from the optical axis than the one part.

10. The image reading device according to claim 1, wherein the protruding portion is configurated by a rotary member attached to the rotary body.

11. The image reading device according to claim 10, wherein the rotary member rotates about a rotation axis extending along the axial direction of the rotary body.

12. The image reading device according to claim 10, wherein
an outer surface of the rotary body includes a plurality of plane surfaces whose positions in a circumferential direction of the rotary body are different from each other,
when the image reading section reads the image, one plane surface out of the plurality of plane surfaces faces the image reading section, and
the rotary member is provided in a form that a part of the rotary member protrudes from the one plane surface.

13. The image reading device according to claim 10, wherein
an outer surface of the rotary body includes a plurality of plane surfaces whose positions in a circumferential direction of the rotary body are different from each other,
when the image reading section reads the image, one plane surface out of the plurality of plane surfaces faces the image reading section, and the other plane surface next to the one plane surface is located upstream of the one plane surface in a moving direction of the recording medium, and
the rotary member configurating the protruding portion is provided at a joint portion between the one plane surface and the other plane surface.

14. An image reading device comprising:
a transport section that transports a recording medium along a transport path;
an image reading section that is provided on one side of the transport path and uses a reduction optical system to collect reflected light from the recording medium onto a light receiving unit and read an image formed on the recording medium;
a rotary body that is rotatably provided and is provided on a side opposite to an installation side of the image reading section across the transport path; and
a protruding portion that is provided on the rotary body, is provided at least at an area deviated from an optical axis of the reflected light directed from the recording medium to the light receiving unit, and protrudes from the rotary body toward the image reading section side.

15. The image reading device according to claim 14, wherein the protruding portion is configurated by a rotary member or a plate-like elastic body.

16. The image reading device according to claim 15, wherein the rotary member rotates about a rotation axis extending along the axial direction of the rotary body.

17. An image forming system comprising:
an image forming section that forms an image on a recording medium; and
an image reading device that reads the image formed on the recording medium by the image forming section, wherein
the image reading device is configurated by including the image reading device according to claim 1.

18. An image forming system comprising:
an image forming section that forms an image on a recording medium; and
an image reading device that reads the image formed on the recording medium by the image forming section, wherein
the image reading device is configurated by including the image reading device according to claim 2.

19. An image forming system comprising:
an image forming section that forms an image on a recording medium; and
an image reading device that reads the image formed on the recording medium by the image forming section, wherein
the image reading device is configurated by including the image reading device according to claim 3.

20. An image forming system comprising:
an image forming section that forms an image on a recording medium; and
an image reading device that reads the image formed on the recording medium by the image forming section, wherein
the image reading device is configurated by including the image reading device according to claim 4.
